(19) United States
(12) Patent Application Publication
(10) Pub. No.: US 2007/0220513 A1
(43) Pub. Date: Sep. 20, 2007

(54) Automatic detection of hang, bottleneck and deadlock

(75) Inventor: Jinwoo Hwang, Morrisville, NC (US)

Correspondence Address: HAMILTON & TERRILE, LLP, P.O. BOX 203518, AUSTIN, TX, 78720, US

(73) Assignee: International Business Machines Corporation, Armonk, NY (US)

(21) Appl. No.: 11/375,765

(22) Filed: Mar. 15, 2006

(51) Int. Cl. G06F 9/455

(52) U.S. Cl. 718/1

(57) ABSTRACT

A method, apparatus and computer-usable medium for automatically detecting hangs, deadlocks and bottlenecks in a virtual machine environment through analysis of thread dumps. Stack traces for each thread are monitored for a predetermined period of time, with a predetermined number of thread dumps and time intervals between the generation of thread dumps. Locked objects are located along with waiting and locking software threads, which are then analyzed to determine if they are potentially stuck in a circular wait condition or waiting on themselves. Analysis can be performed in both on-line and off-line modes through graphical depictions of thread and resource contentions to identify hangs, deadlocks and bottlenecks.

### BACKGROUND OF THE INVENTION

1. Field of the Invention

The present invention relates in general to the field of computers and similar technologies, and in particular to software utilized in this field. Still more particularly, the present invention relates to identifying thread and resource contention.

2. Description of the Related Art

The use of the Java platform, from Sun Microsystems, Inc., by the software development community continues to grow in popularity. This is partly due to the advantages of the Java programming language, which is object-oriented, distributed, multi-threaded and portable. Object-oriented programming languages such as Java provide programmers flexibility in creating modules as one object can inherit the characteristics of another object, contributing to flexible and reusable software components. As a result, development timelines can be shortened, allowing developers to devote more time to other aspects of the software development lifecycle.

A feature of the Java Platform is its support for multi-threading at the language level, which allows two or more program execution threads to run concurrently, each performing a separate process. Sometimes during concurrent thread operations a hang, deadlock or bottleneck situation occurs when a first thread owns a first resource and wants to acquire a second resource that is owned by a second thread. For the first thread to acquire the second resource, the second resource must first be released by the second thread. However, if the second thread is waiting for the first thread to release the first resource, then the second thread can be held in a wait state, creating a situation where neither thread can proceed. Furthermore, a circular wait condition can occur if more than two threads are involved, as each thread may hold a resource the other threads are trying to acquire. A similar situation occurs when a thread is waiting on a resource it already owns possibly, introducing an infinite wait condition.

Hangs, deadlocks and bottlenecks are known problems in concurrent programming environments. Various approaches have been suggested to mitigate the issue, including the use of programming techniques to avoid them. For example, objects can be assigned a numeric value and ordered such that resource locks are obtained by threads in a predetermined numeric sequence at runtime. However, this approach requires incorporation into the design of the application and catches exceptions only as they occur. Another approach is the use of a profiler agent to interact with a currently running Java Virtual Machine (JVM), which notifies the profiler agent of various events such as heap allocation, thread start, etc. However, this approach is limited to monitoring events triggered by the JVM and only when the JVM is running. A profiler agent does not provide user analysis at the front end.

### SUMMARY OF THE INVENTION

The present invention includes, but is not limited to, a method, apparatus and computer-usable medium for automatically detecting hangs, deadlocks and bottlenecks in a virtual machine environment, such as a WebSphere Application server from IBM, in both on-line and off-line modes through analysis of thread dumps, providing graphical depictions of thread and resource contentions, including threads that are deadlocked in a circular wait condition and threads that are perpetually waiting on themselves, to provide alerts to potential problems as they develop.

In different embodiments of the invention, stack traces for each thread are monitored for a predetermined period of time (e.g., ten minutes) with a predetermined number of thread dumps (e.g., three) and a predetermined time interval (e.g., three minutes) between the generation of thread dumps for analysis. Locked objects are located along with waiting and locking software threads, which are then analyzed to determine if they are potentially stuck in a circular wait condition or waiting on themselves.

Thread stack traces from two or more thread dumps are compared to identify threads that have the same stack trace, which are marked as hung and then graphically depicted as such through a user interface. Thread graphs are created from a monitor table and depth-first search trees are created to identify loops, which if found, are marked as deadlocks and similarly depicted as such through a graphical user interface (GUI). Each tree level is sorted by the number of waiting threads and if a hung thread is found in a tree, its root thread is located and marked as a bottleneck, and then likewise depicted through the GUI along with hung threads not found in the tree. The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an exemplary client computer in which the present invention may be implemented;

FIG. 2 illustrates an exemplary server from which software for executing the present invention may be deployed and/or implemented for the benefit of a user of the client computer shown in FIG. 1;

FIG. 3 shows a generalized depiction of a two dimensional matrix as implemented in accordance with an embodiment of the invention to store the respective status of software threads holding resources versus threads waiting on resources;

FIGS. 4a-b show a generalized flow chart of an implementation of a thread activity monitor (TAM) as used in accordance with an embodiment of the present invention for identifying hangs, deadlocks and bottlenecks from a thread dump file;

FIG. 5 shows a generalized illustration of a depiction of the operational state of one or more software threads and their associated resources;

FIG. 6 shows a graphical depiction of a software thread as running with an associated resource and remaining in an unchanged operational state between a first, second and third thread dump.

FIG. 7 shows a graphical depiction of a software thread as waiting for an associated resource and remaining in an unchanged operational state between a first, second and third thread dump.

FIG. 8 shows a graphical depiction of a software thread as running with no associated resource and remaining in an unchanged operational state between a first, second and third thread dump;

FIG. 9 shows a graphical depiction of a software thread as changing from waiting to running when its associated resources change between a first, second and third thread dump;

FIG. 10 shows a graphical depiction a software thread as changing from running with no associated resources to waiting with associated resources between a first, second and third thread dump;

FIG. 11 shows a graphical depiction of a depth-first search tree of a thread monitor dump;

FIG. 12 shows a graphical depiction of a thread and monitor comparison table;

FIGS. 13a-b show a flow-chart of steps taken to deploy software capable of executing the steps shown and described in FIGS. 3-12;

FIGS. 14a-c show a flow-chart of steps taken to deploy in a Virtual Private Network (VPN) software that is capable of executing the steps shown and described in FIGS. 3-12;

FIGS. 15a-b show a flow-chart showing steps taken to integrate into a computer system software that is capable of executing the steps shown and described in FIGS. 3-12; and

FIGS. 16a-b show a flow-chart showing steps taken to execute the steps shown and described in FIGS. 3-12 using an on-demand service provider.

### DETAILED DESCRIPTION

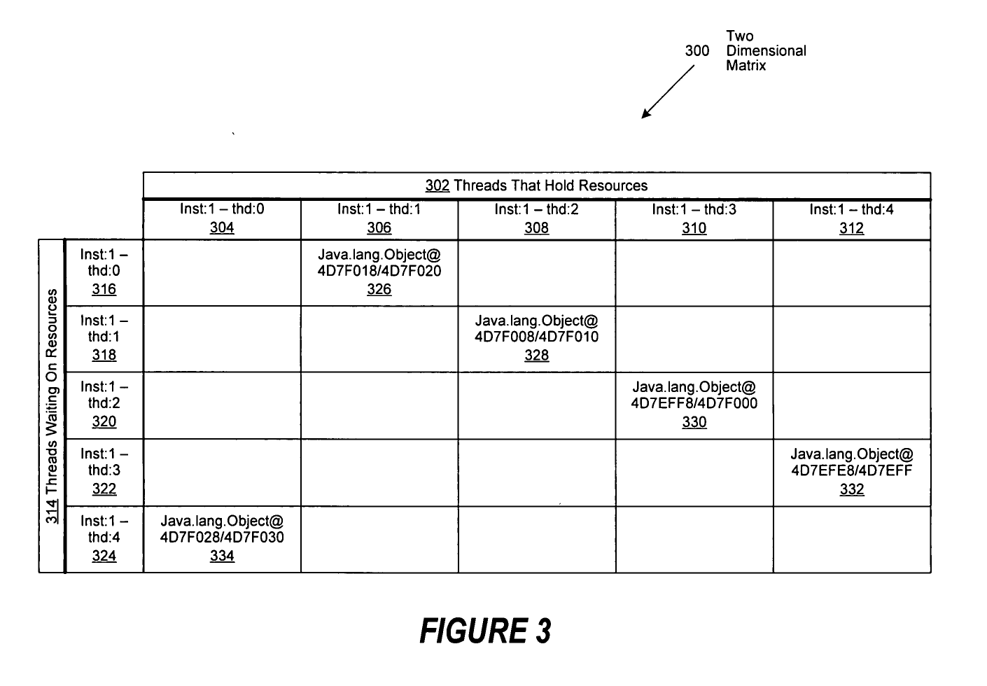

With reference now to the figures, and in particular to FIG. 3, there is depicted a method, apparatus and computer-usable medium for automatically detecting hangs, deadlocks and bottlenecks in a virtual machine environment, such as a WebSphere Application server from IBM, in both on-line and off-line modes through analysis of thread dumps, and providing graphical depictions of thread and resource contentions, including threads that are deadlocked in a circular wait condition and threads that are perpetually waiting on themselves, to provide alerts to potential problems as they develop.

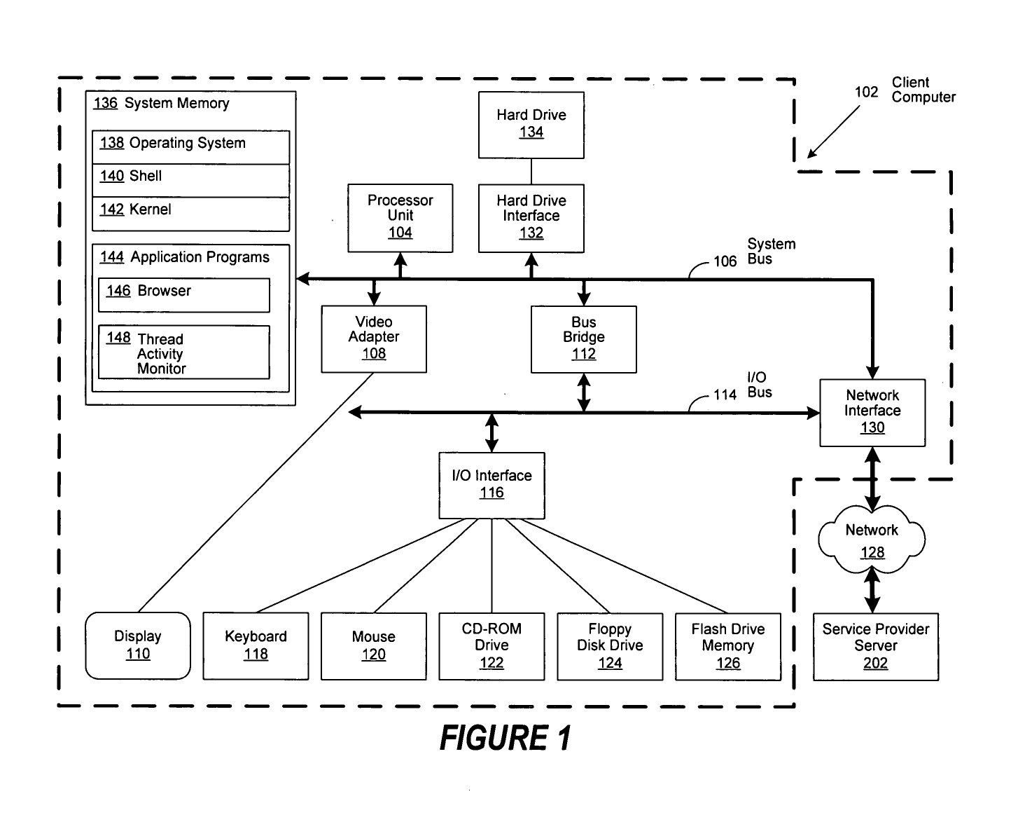

With reference now to FIG. 1, there is depicted a block diagram of an exemplary client computer 102, in which the present invention may be utilized. Client computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 416 may be any known to those skilled in the art of computer architecture, including but not limited to Universal Serial Bus (USB) ports.

Client computer 102 is able to communicate with a service provider server 202 via a network 128 using a network interface 130, which is coupled to system bus 106. Network 128 may be an external network such as the Internet, or an internal network such as an Ethernet or a Virtual Private Network (VPN). Using network 128, client computer 102 is able to use the present invention to access service provider server 202.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 202.

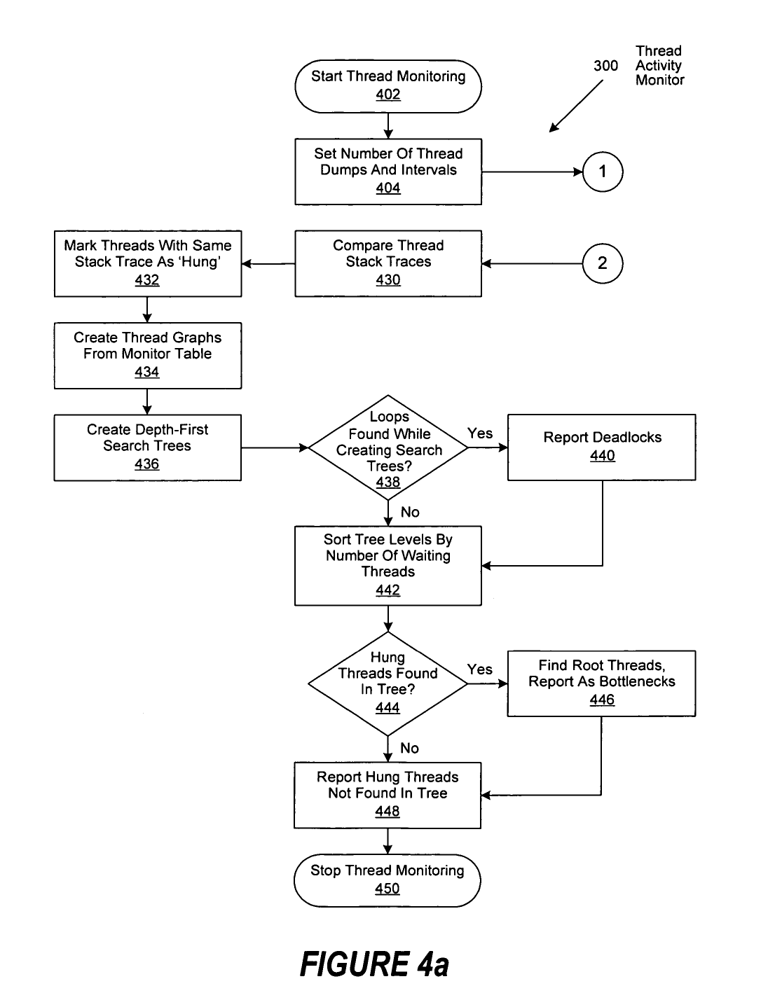

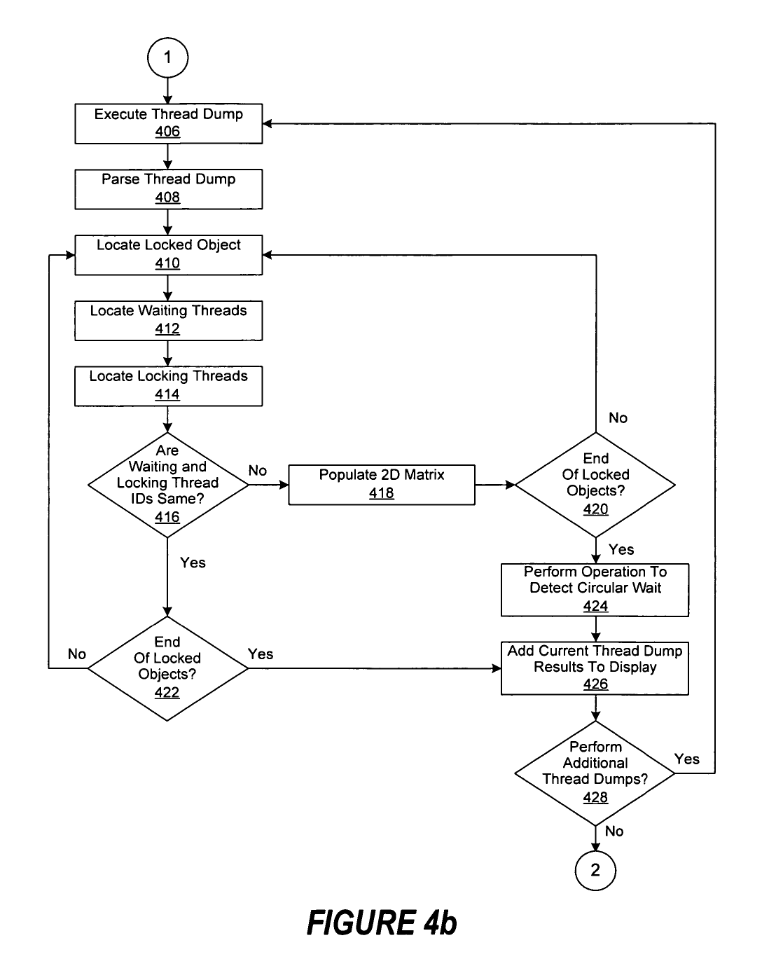

Application programs 144 in client computer 102's system memory also include an Thread Activity Monitor 148. Thread Activity Monitor 148 includes code for implementing the processes described in FIGS. 4a-b. In one embodiment, client computer 102 is able to download Thread Activity Monitor 148 from service provider server 202.

The hardware elements depicted in client computer 102 are not intended to be exhaustive, but rather are representative to highlight essential components required by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

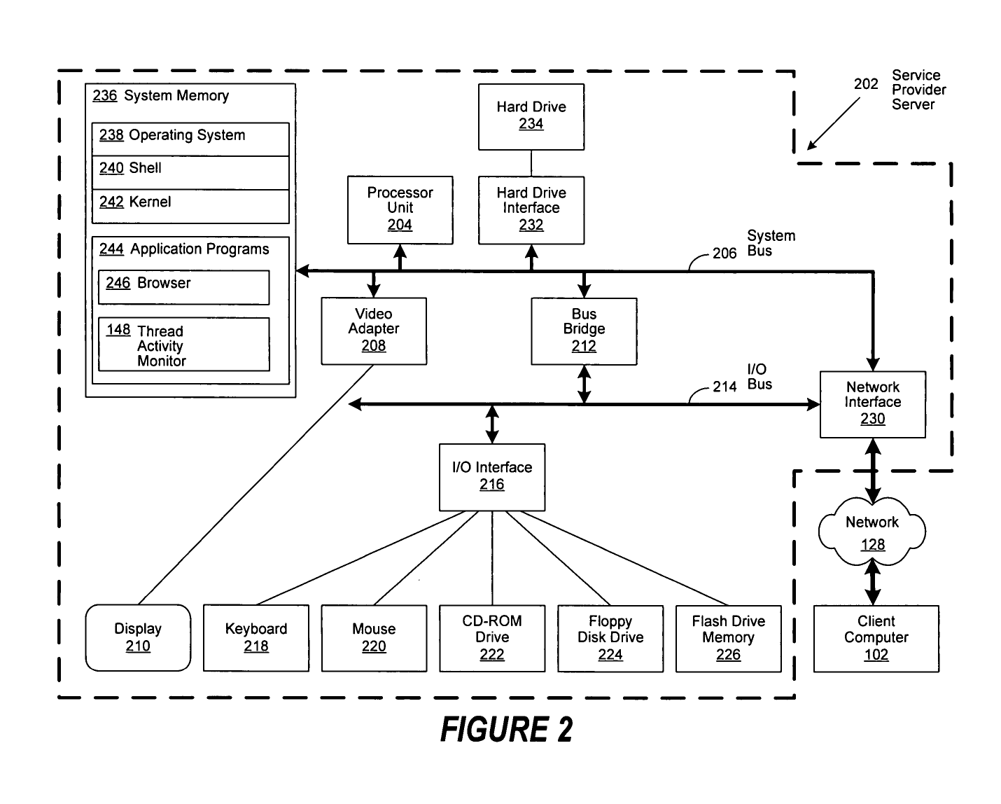

As noted above, Thread Activity Monitor 148 can be downloaded to client computer 202 from service provider server 202, shown in exemplary form in FIG. 2. Service provider server 202 includes a processor unit 204 that is coupled to a system bus 206. A video adapter 208 is also coupled to system bus 206. Video adapter 208 drives/supports a display 210. System bus 206 is coupled via a bus bridge 212 to an Input/Output (I/O) bus 214. An I/O interface 216 is coupled to I/O bus 214. I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

Service provider server 202 is able to communicate with client computer 102 via network 128 using a network interface 230, which is coupled to system bus 206. Access to network 128 allows service provider server 202 to execute and/or download Thread Activity Monitor 148 to client computer 102.

System bus 206 is also coupled to a hard drive interface 232, which interfaces with a hard drive 234. In a preferred embodiment, hard drive 234 populates a system memory 236, which is also coupled to system bus 206. Data that populates system memory 236 includes service provider server 202's operating system 238, which includes a shell 240 and a kernel 242. Shell 240 is incorporated in a higher level operating system layer and utilized for providing transparent user access to resources such as application programs 244, which include a browser 246, and a copy of Thread Activity Monitor 148 described above, which can be deployed to client computer 102.

The hardware elements depicted in service provider server 202 are not intended to be exhaustive, but rather are representative to highlight essential components required by the present invention. For instance, service provider server 202 may include alternate memory storage devices such as flash drives, magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 202 performs all of the functions associated with the present invention (including execution of Thread Activity Monitor 148), thus freeing client computer 102 from using its resources.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

FIG. 3 shows a generalized depiction of a two dimensional matrix 300 to store the respective status of software threads holding resources versus threads waiting on resources. The resource can be anything that can be associated with a thread. For example, a monitor object, a thread state, a stuck trace pattern or a transaction state. Two dimensional matrix 300 comprises software threads holding resources 302 across the top of the matrix and software threads waiting on resources 314 on the side of the matrix. Software threads holding resources 302 comprise threads 304, 306, 308, 310, 312 and software threads waiting on resources 314 similarly comprise threads 316, 318, 320, 322, 324. In this illustration, resource Java.lang.object at memory address 4DF018/4D7F020 326 is held by thread Inst: 1-thd:1 306 and thread Inst1-:thd:0 316 is waiting for the resource. Likewise, resource Java.lang.object at memory address 4DF008/4D7F010 328 is held by thread Inst: 1-thd:2 308 and thread Inst:1-thd:1 318 is waiting for the resource; resource Java.lang.object at memory address 4DEFF8/4D7F000 330 is held by thread Inst: 1-thd:3 310 and thread Inst:1-thd:2 320 is waiting for the resource; resource Java.lang.object at memory address 4DEFE8/4D7EFF 332 is held by thread Inst:1-thd:4 312 and thread Inst:1-thd:3 322 is waiting for the resource; and resource Java.lang.object at memory address 4DF028/4D7F030 334 is held by thread Inst: 1-thd:0 304 and thread Inst:1-thd:4 324 is waiting for the resource.

FIGS. 4a-b show a generalized flow chart of a thread activity monitor (TAM) 148 for identifying hangs, deadlocks and bottlenecks from a thread dump file. Monitoring of thread activity starts at Step 402 for a predetermined period of time (e.g., ten minutes), with a predetermined number of thread dumps (e.g., three) and a predetermined time interval (e.g., three minutes) between thread dumps being set in Step 404. For example, thread activity monitor (TAM) 148 may be implemented to monitor stack traces of each thread for ten minutes and generate three thread and monitor dumps three minutes apart for any non-idle thread that has the same stack trace during the predetermined monitoring given interval.

The stack trace patterns of idle threads are stored to identify whether a thread is idle or not. The following is an example of an idle thread in WebSphere Application Server v5:

Servlet.Engine.Transports: 20″ (TID:0x427F190, sys_thread_t:0x15D175E8, state:R, native ID:0xBB8) prio=5

at java.lang.Object.wait(Native Method)

at java.lang.Object.wait(Objectjava:429)

at com.ibm.ws.util.BoundedBuffer.take(BoundedBuffer.java: 161)

at com.ibm.ws.util.ThreadPool.getTask(ThreadPool.java(Compiled Code))

at com.ibm.ws.util.ThreadPool$Worker.run(ThreadPool.java(Compiled Code))

Thread dumps can be automatically generated by various applications (e.g., Java virtual machine, WebSphere application server, etc.) or manually by users. The first thread dump is executed in Step 406 and then parsed in Step 408. Locked objects are located in Step 410, with waiting software threads located in Step 412, followed by the location of locking software threads in Step 414.

Threads can be analyzed to determine if they are potentially stuck in a circular wait condition or waiting on themselves. If the waiting and locking thread IDs are determined to not be the same in Step 416, analysis is performed to determine whether a possible deadlock condition exists, and their respective and associated information is stored in a two dimensional matrix in Step 418. If it is determined in Step 420 that the last locked object has not been reached, then the next locked object is located in Step 410. Otherwise, an operation is performed to detect circular wait states in Step 424, and the current thread dump results are then added to a graphical display in Step 426.

If the waiting and locking thread IDs are determined to be the same in Step 416, analysis is performed to determine whether the threads are waiting on themselves, and then in Step 422 it is determined whether the last locked object has been reached. If it has not, then the next locked object is located in Step 410, otherwise the current thread dump results are then added to a graphical display in Step 426. If it is determined in Step 428 that additional thread dumps are to be performed based on the predetermined number of thread dumps and the predetermined time interval between thread dumps set in Step 404, then an additional thread dump is executed in Step 406. Otherwise, thread stack traces are compared in Step 430 and threads with the same stack trace are marked as “hung” in Step 432.

Thread graphs are then created from the monitor table in Step 434 and depth-first search trees are created in Step 436. If loops were found while creating search trees in Step 438, then deadlocks are reported in Step 440 and tree levels are then sorted by the number of waiting threads in Step 442. If loops were not found while creating search trees in Step 438, tree levels are sorted by the number of waiting threads in Step 442 and if hung threads are found in a tree in Step 444, then the root thread is located and reported as a bottleneck in Step 446. Hung threads not found in a tree are then reported in Step 448, with thread monitoring ending in Step 450.

For example:

Servlet.Engine.Transports:313 is waiting on Servlet.Engine.Transports:243, which is waiting on Servlet.Engine.Transports:140.

Report Servlet.Engine.Transports: 140 as a bottleneck.

If hung threads are not found in a tree in Step 444, then hung threads not found in a tree are reported in Step 448 and thread monitoring ends in Step 450. In one embodiment of the invention, the analysis is performed while a monitored application, such as a JVM, is executing. In another embodiment of the invention, the analysis is performed against two or more thread dump files that have been saved, allowing identification of hangs, deadlocks and bottlenecks when an application is not executing.

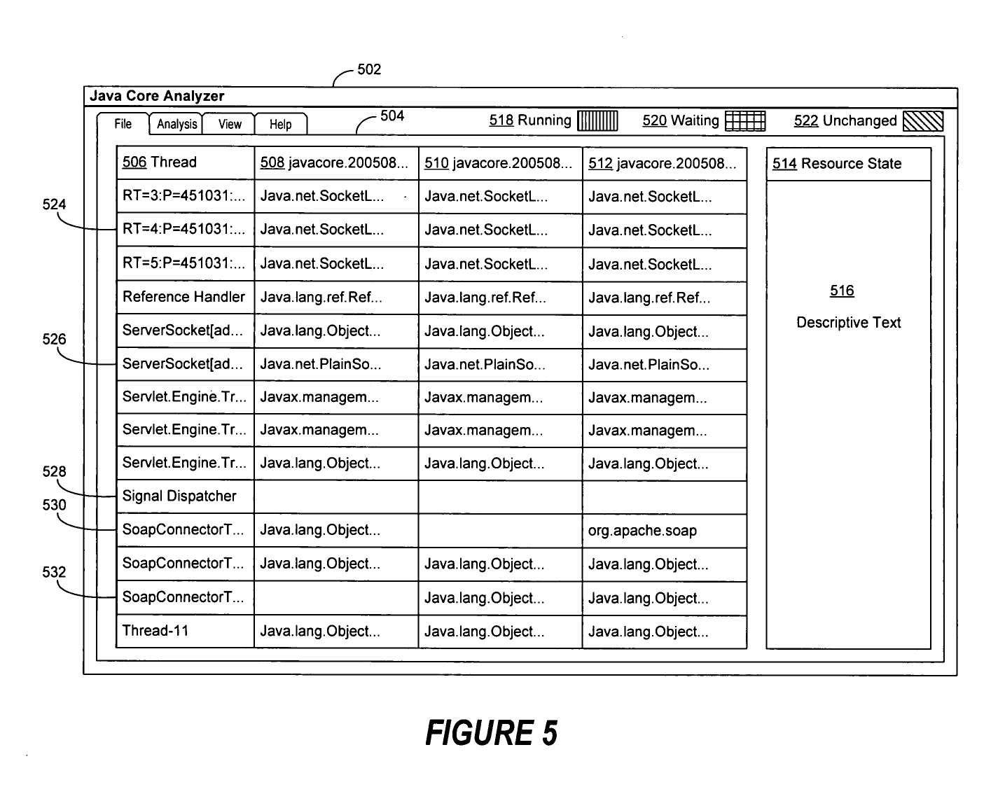

FIG. 5 shows a graphical depiction of the operational state of one or more software threads and their associated resources. The resource can be anything that can be associated with a thread. For example, a monitor object, a thread state, a stack trace pattern or a transaction state. Graphical user interface (GUI) 502 comprises TAM window 504 and thread status indicator legends for a thread that is running 518, a thread that is waiting for resources 520, and a thread whose status is unchanged from the last thread dump 522. As described in greater detail below, operational status of a thread is typically indicated through, but is not limited to, the use of colored borders, backgrounds, or text.

TAM window 504 comprises thread list window 506, thread dump windows 508, 510, 512 and resource state information window 514. Thread dumps comprising thread dump windows 508, 510, 512 are produced at predetermined time intervals and list resources currently owned by individual threads (e.g., 524, 526, 528, 530, 532), with detail associated with their operational state presented as descriptive text 516 in resource state information window 514. The operational state of resources in thread dumps comprising thread dump windows 508, 510, 512, as they relate to individual threads that own them (e.g., 524, 526, 528, 530, 532), is graphically depicted through the implementation of colored borders, backgrounds and/or text within each displayed field as described in greater detail hereinbelow.

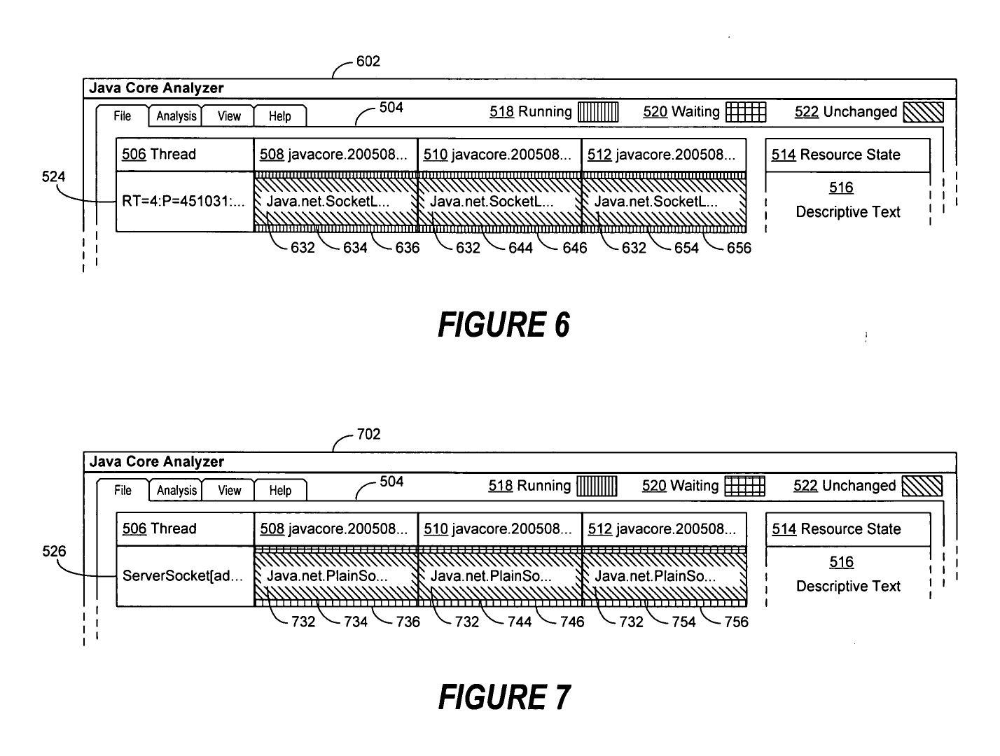

FIG. 6 shows a graphical depiction of a software thread 524 as running with associated resource 632 and remaining in an unchanged operational state between a first, second and third thread dump comprising thread dump windows 508, 510, 512. Graphical user interface (GUI) 602 comprises TAM window 504 and thread status indicator legends for a thread that is running 518, a thread that is waiting for resources 520, and a thread whose status is unchanged from the last thread dump 522. Thread 524, comprising thread list window 506, is associated with resource 632, comprising a first thread dump as depicted in thread dump window 508, a second thread dump as depicted in thread dump window 510, and a third thread dump as depicted in thread dump window 512.

The operational status of thread 524 being in a running state with associated resource 632 is depicted through the use of a predetermined border color 636, 646, 656 respectively in thread dump windows 508, 510, 512, corresponding to the color implemented in thread status indicator 518. The unchanged operational status of thread 524 between a first, second and third thread dump, as it relates to associated resource 632, is depicted through the use of a predetermined background color 634, 644, 654 respectively in thread dump windows 508, 510, 512, corresponding to the color implemented in thread status indicator 522. Detail information associated with the operational status of thread 524, as it relates to associated resource 632, is presented as descriptive text 516 in resource state information window 514.

FIG. 7 shows a graphical depiction of a software thread 526 as waiting for associated resource 732 and remaining in an unchanged operational state between a Graphical user interface (GUI) 702 comprises TAM window 504 and thread status indicator legends for a thread that is running 518, a thread that is waiting for resources 520, and a thread whose status is unchanged from the last thread dump 522. Thread 526, comprising thread list window 506, is associated with resource 732, comprising a first thread dump as depicted in thread dump window 508, a second thread dump as depicted in thread dump window 510, and a third thread dump as depicted in thread dump window 512.

The operational status of thread 526 being in a waiting state for associated resource 732 is depicted through the use of a predetermined border color 736, 746, 756 respectively in thread dump windows 508, 510, 512, corresponding to the color implemented in thread status indicator 520. The unchanged operational status of thread 526 between a first, second and third thread dump, as it relates to associated resource 732, is depicted through the use of a predetermined background color 734, 744, 754 respectively in thread dump windows 508, 510, 512, corresponding to the color implemented in thread status indicator 522. Detail information associated with the operational status of thread 526, as it relates to associated resource 732, is presented as descriptive text 516 in resource state information window 514.

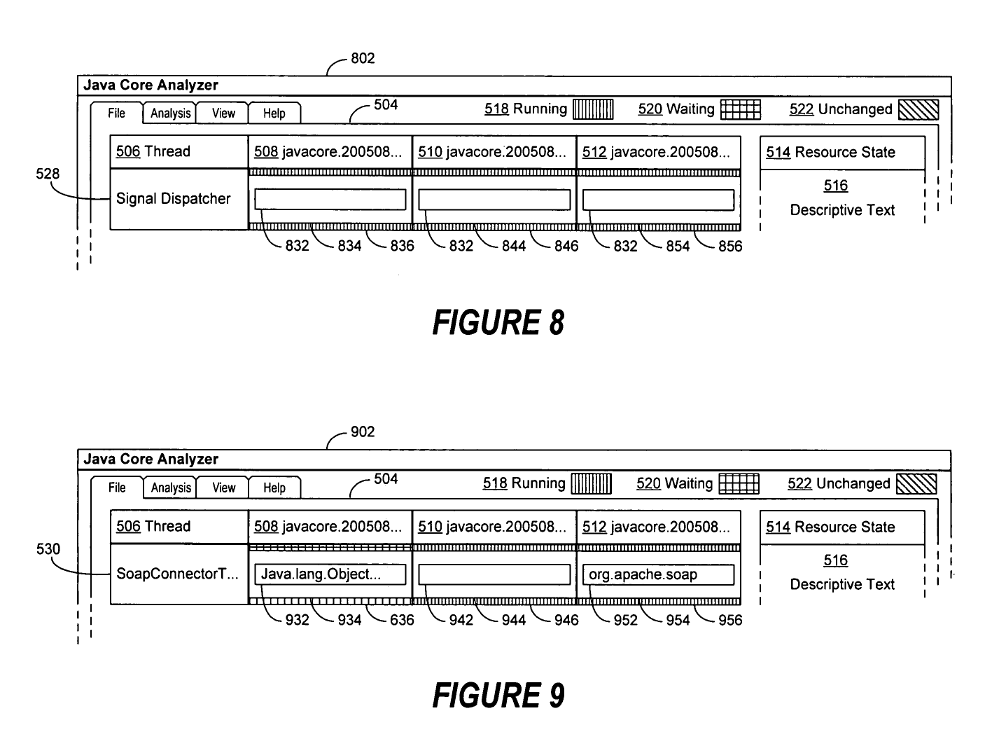

FIG. 8 shows a graphical depiction of a software thread 528 as running with no associated resource 832 and remaining in an unchanged operational state between a first, second and third thread dump comprising thread dump windows 508, 510, 512. Graphical user interface (GUI) 802 comprises TAM window 504 and thread status indicator legends for a thread that is running 518, a thread that is waiting for resources 520, and a thread whose status is unchanged from the last thread dump 522. Thread 528, comprising thread list window 506, is associated with no resource 832, comprising a first thread dump as depicted in thread dump window 508, a second thread dump as depicted in thread dump window 510, and a third thread dump as depicted in thread dump window 512.

The operational status of thread 528 being in a running state with no associated resource 832 is depicted through the use of a predetermined border color 836, 846, 856 respectively in thread dump windows 508, 510, 512, corresponding to the color implemented in thread status indicator 518. The unchanged operational status of thread 528 between a first, second and third thread dump, as it relates to the absence of associated resource 832, is depicted through the absence of predetermined background color 834, 844, 854 respectively in thread dump windows 508, 510, 512. Detail information associated with the operational status of thread 528, as it relates to the absence of associated resource 832, is presented as descriptive text 516 in resource state information window 514.

FIG. 9 shows a graphical depiction of a software thread 530 as changing from waiting to running when its associated resources change between a first, second and third thread dump comprising thread dump windows 508, 510, 512. Graphical user interface (GUI) 902 comprises TAM window 504 and thread status indicator legends for a thread that is running 518, a thread that is waiting for resources 520, and a thread whose status is unchanged from the last thread dump 522. Thread 530, comprising thread list window 506, is associated with resource 932, comprising a first thread dump as depicted in thread dump window 508, no associated resource 942, comprising a second thread dump as depicted in thread dump window 510, and associated resource 952, comprising a third thread dump as depicted in thread dump window 512.

The operational status of thread 530 changing from waiting to running when its associated resources change is depicted through the use of predetermined border color 936 in thread dump windows 508, corresponding to the color implemented in thread status indicator 520, signifying that thread 530 is waiting on a first associated resource 932, predetermined border color 946 in thread dump windows 510, corresponding to the color implemented in thread status indicator 518, signifying that thread 530 is running with no associated resource 942, and predetermined border color 956 in thread dump windows 512, corresponding to the color implemented in thread status indicator 518, signifying that thread 530 is running with a second associated resource 952. The changed operational status of thread 528 between a first, second and third thread dump, as it relates to the changing of associated resources 932, 942, 952 is depicted through the absence of predetermined background color 934, 944, 954 respectively in thread dump windows 508, 510, 512. Detail information associated with the changing operational status of thread 530, as it relates to absence of associated resource 942 and association with resources 942, 952, is presented as descriptive text 516 in resource state information window 514.

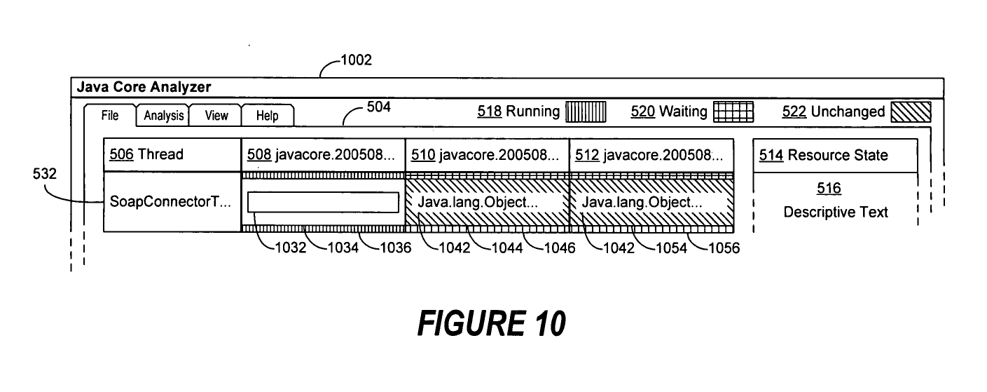

FIG. 10 shows a graphical depiction of a software thread 532 as changing from running with no associated resources to waiting with associated resources between a first, second and third thread dump comprising thread dump windows 508, 510, 512. Graphical user interface (GUI) 1002 comprises TAM window 504 and thread status indicator legends for a thread that is running 518, a thread that is waiting for resources 520, and a thread whose status is unchanged from the last thread dump 522. Thread 532, comprising thread list window 506, is associated with no associated resource 1032, comprising a first thread dump as depicted in thread dump window 508, associated resource 1042, comprising a second thread dump as depicted in thread dump window 510, and a third thread dump as depicted in thread dump window 512.

The operational status of thread 532 changing from running with no associated resources to waiting with associated resources is depicted through the use of predetermined border color 1036 in thread dump windows 508, corresponding to the color implemented in thread status indicator 518, signifying that thread 530 is running with no associated resource 1032, and predetermined border color 1044, 1054 respectively in thread dump windows 510, 512 corresponding to the color implemented in thread status indicator 520, signifying that thread 530 is waiting on associated resource 1042. The changed operational status of thread 528 between a first, second and third thread dump, as it relates to the changing from no associated resource 1032 to associated resources, 1042, 1052 is depicted through the absence of predetermined background color 1034, in thread dump window 508 and predetermined background color 944, 954 respectively in thread dump windows, 510, 512. Detail information associated with the changing operational status of thread 532, as it relates to the absence of associated resource 1032 and association with resources 1042, 1052, is presented as descriptive text 516 in resource state information window 514.

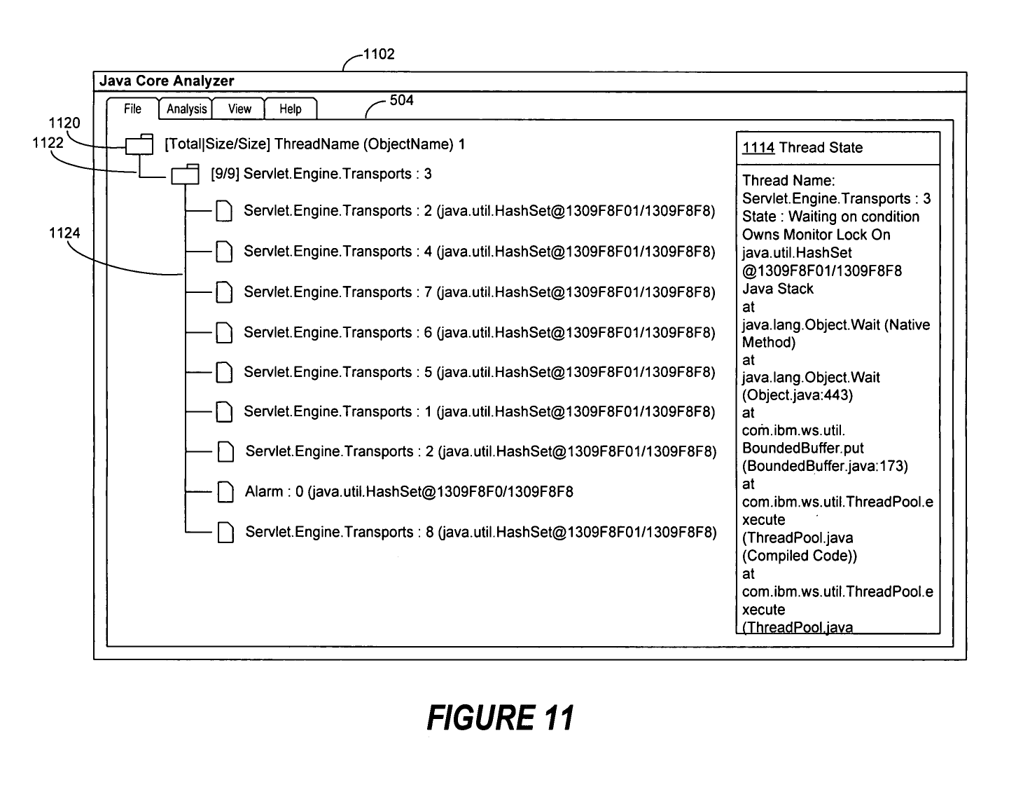

FIG. 11 shows a graphical depiction of a depth-first search tree of a thread monitor dump. Graphical user interface (GUI) 1102 comprises TAM window 504, which comprises a depth-first search tree view of monitor dump 1120, indicating nine threads 1122 are waiting on monitorjava.util.HashSet@1309F8F0/1309F8F8. GUI 1102 further indicates that thread Servlet.Engine.Transports:3 1124 owns lock on the monitor, causing other threads to wait until the monitor is unlocked, thereby locating the cause of thread contention. Detail information associated with the changing operational status of threads 1120 is presented in resource state information window 1114.

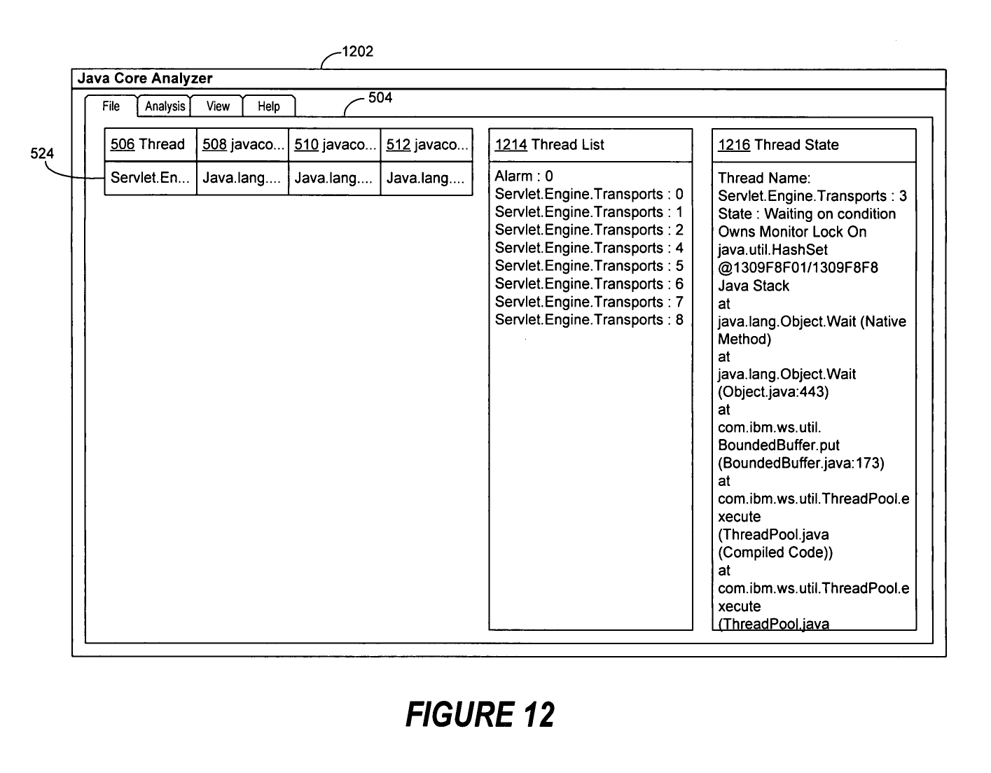

FIG. 12 shows a graphical depiction of a thread and monitor comparison table. Graphical user interface (GUI) 1202 comprises TAM window 504, which comprises a thread and monitor comparison table comprising thread list window 506, thread dump windows 508, 510, 512, and thread state information window 1216. Thread 524, and associated resource information in depicted in thread list window 506 and thread dump windows 508, 510, 512. Threads waiting for the resource are depicted in thread list window 1214 and thread state information is depicted in thread state window 1216.

Thus, the method described herein, and in particular as shown and described in FIGS. 4a-b, can be deployed as a process software from service provider server 202 to client computer 102.

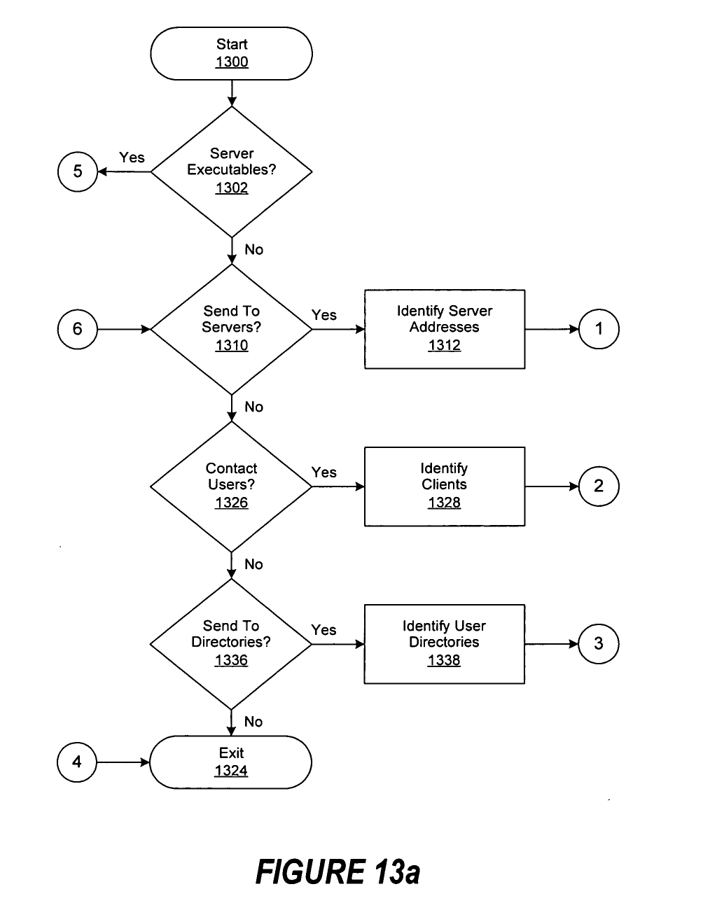

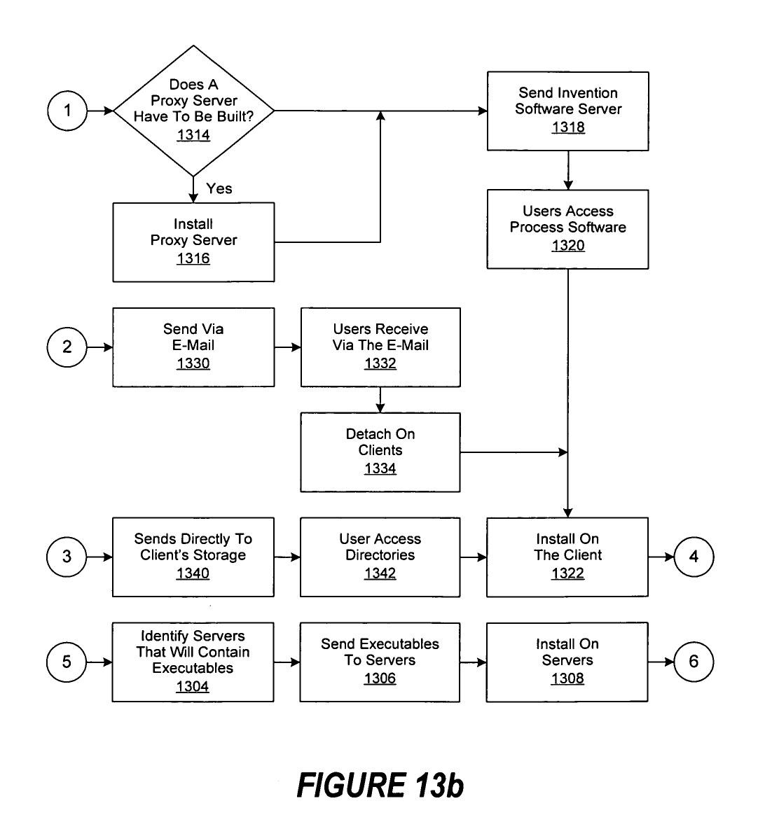

Referring then to FIG. 13, step 1300 begins the deployment of the process software. The first thing is to determine if there are any programs that will reside on a server or servers when the process software is executed (query block 1302). If this is the case, then the servers that will contain the executables are identified (block 1304). The process software for the server or servers is transferred directly to the servers' storage via File Transfer Protocol (FTP) or some other protocol or by copying though the use of a shared file system (block 1306). The process software is then installed on the servers (block 1308).

Next, a determination is made on whether the process software is to be deployed by having users access the process software on a server or servers (query block 1310). If the users are to access the process software on servers, then the server addresses that will store the process software are identified (block 1312).

A determination is made if a proxy server is to be built (query block 1314) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 1316). The process software is sent to the servers either via a protocol such as FTP or it is copied directly from the source files to the server files via file sharing (block 1318). Another embodiment would be to send a transaction to the servers that contained the process software and have the server process the transaction, then receive and copy the process software to the server's file system. Once the process software is stored at the servers, the users, via their client computers, then access the process software on the servers and copy to their client computers file systems (block 1320). Another embodiment is to have the servers automatically copy the process software to each client and then run the installation program for the process software at each client computer. The user executes the program that installs the process software on his client computer (block 1322) then exits the process (terminator block 1324).

In query step 1326, a determination is made whether the process software is to be deployed by sending the process software to users via e-mail. The set of users where the process software will be deployed are identified together with the addresses of the user client computers (block 1328). The process software is sent via e-mail to each of the users' client computers (block 1330). The users then receive the e-mail (block 1332) and then detach the process software from the e-mail to a directory on their client computers (block 1334). The user executes the program that installs the process software on his client computer (block 1322) then exits the process (terminator block 1324).

Lastly a determination is made on whether to the process software will be sent directly to user directories on their client computers (query block 1336). If so, the user directories are identified (block 1338). The process software is transferred directly to the user's client computer directory (block 1340). This can be done in several ways such as, but not limited to, sharing of the file system directories and then copying from the sender's file system to the recipient user's file system or alternatively using a transfer protocol such as File Transfer Protocol (FTP). The users access the directories on their client file systems in preparation for installing the process software (block 1342). The user executes the program that installs the process software on his client computer (block 1322) and then exits the process (terminator block 1324).

The present software can be deployed to third parties as part of a service wherein a third party VPN service is offered as a secure deployment vehicle or wherein a VPN is built on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-bee number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

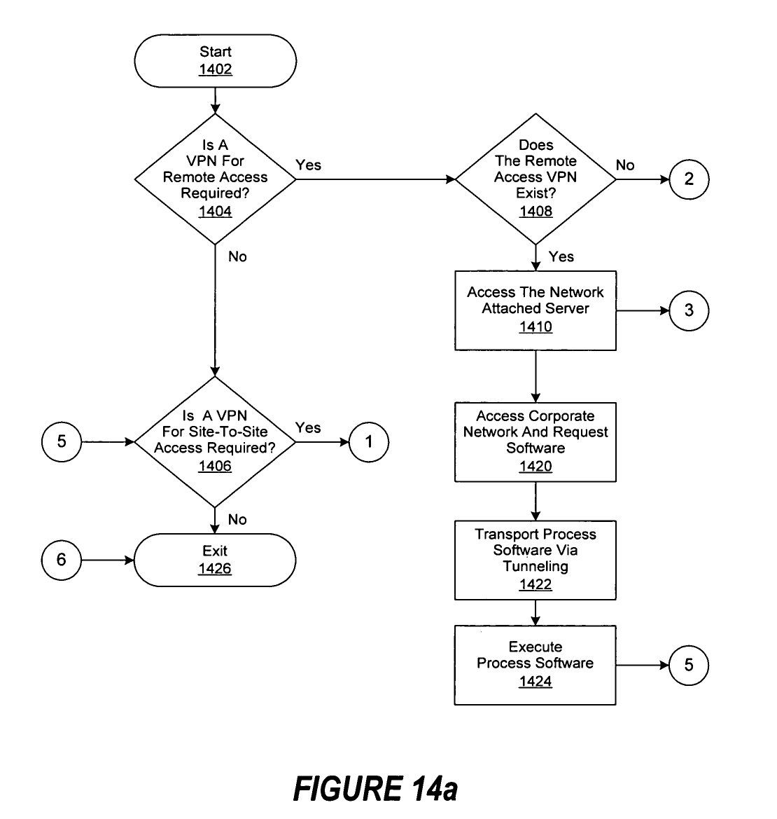

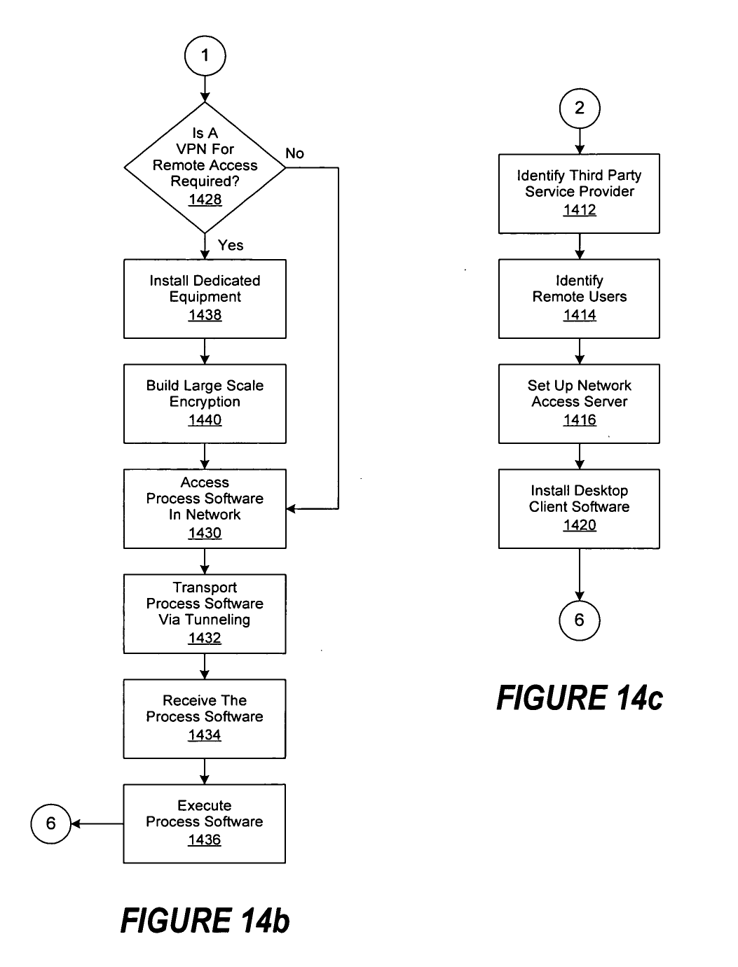

The process for such VPN deployment is described in FIG. 14. Initiator block 1402 begins the Virtual Private Network (VPN) process. A determination is made to see if a VPN for remote access is required (query block 1404). If it is not required, then proceed to query block 1406. If it is required, then determine if the remote access VPN exists (query block 1408).

If a VPN does exist, then proceed to block 1410. Otherwise identify a third party provider that will provide the secure, encrypted connections between the company's private network and the company's remote users (block 1412). The company's remote users are identified (block 1414). The third party provider then sets up a network access server (NAS) (block 1416) that allows the remote users to dial a toll free number or attach directly via a broadband modem to access, download and install the desktop client software for the remote-access VPN (block 1418).

After the remote access VPN has been built or if it been previously installed, the remote users can access the process software by dialing into the NAS or attaching directly via a cable or DSL modem into the NAS (block 1410). This allows entry into the corporate network where the process software is accessed (block 1420). The process software is transported to the remote user's desktop over the network via tunneling. That is, the process software is divided into packets and each packet including the data and protocol is placed within another packet (block 1422). When the process software arrives at the remote user's desktop, it is removed from the packets, reconstituted and then is executed on the remote user's desktop (block 1424).

A determination is then made to see if a VPN for site to site access is required (query block 1406). If it is not required, then proceed to exit the process (terminator block 1426). Otherwise, determine if the site to site VPN exists (query block 1428). If it does not exist, then proceed to block 1430. Otherwise, install the dedicated equipment required to establish a site to site VPN (block 1438). Then build the large scale encryption into the VPN (block 1440).

After the site to site VPN has been built or if it had been previously established, the users access the process software via the VPN (block 1430). The process software is transported to the site users over the network via tunneling (block 1432). That is the process software is divided into packets and each packet including the data and protocol is placed within another packet (block 1434). When the process software arrives at the remote user's desktop, it is removed from the packets, reconstituted and is executed on the site user's desktop (block 1436). The process then ends at terminator block 1426.

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

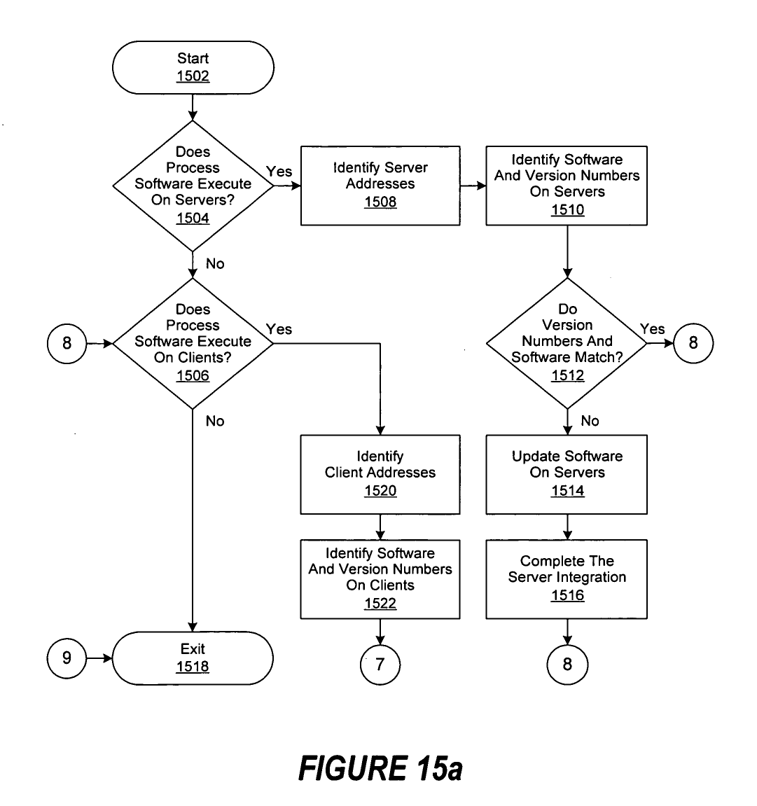

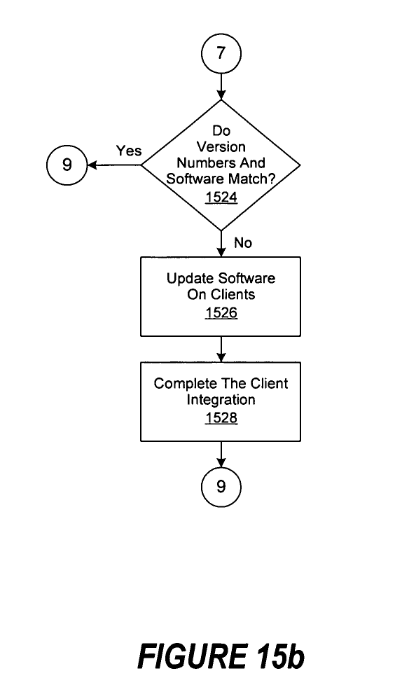

For a high-level description of this process, reference is now made to FIG. 15. Initiator block 1502 begins the integration of the process software. The first tiling is to determine if there are any process software programs that will execute on a server or servers (block 15). If this is not the case, then integration proceeds to query block 1506. If this is the case, then the server addresses are identified (block 1508). The servers are checked to see if they contain software that includes the operating system (OS), applications, and network operating systems (NOS), together with their version numbers, which have been tested with the process software (block 1510). The servers are also checked to determine if there is any missing software that is required by the process software in block 1510.

A determination is made if the version numbers match the version numbers of OS, applications and NOS that have been tested with the process software (block 1512). If all of the versions match and there is no missing required software the integration continues in query block 1506.

If one or more of the version numbers do not match, then the unmatched versions are updated on the server or servers with the correct versions (block 1514). Additionally, if there is missing required software, then it is updated on the server or servers in the step shown in block 1514. The server integration is completed by installing the process software (block 1516).

The step shown in query block 1506, which follows either the steps shown in block 1504, 1512 or 1516 determines if there are any programs of the process software that will execute on the clients. If no process software programs execute on the clients the integration proceeds to terminator block 1518 and exits. If this not the case, then the client addresses are identified as shown in block 1520.

The clients are checked to see if they contain software that includes the operating system (OS), applications, and network operating systems (NOS), together with their version numbers, which have been tested with the process software (block 822). The clients are also checked to determine if there is any missing software that is required by the process software in the step described by block 1522.

A determination is made is the version numbers match the version numbers of OS, applications and NOS that have been tested with the process software (query block 1524). If all of the versions match and there is no missing required software, then the integration proceeds to terminator block 1518 and exits.

If one or more of the version numbers do not match, then the unmatched versions are updated on the clients with the correct versions (block 1526). In addition, if there is missing required software then it is updated on the clients (also block 1526). The client integration is completed by installing the process software on the clients (block 1528). The integration proceeds to terminator block 1518 and exits.

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

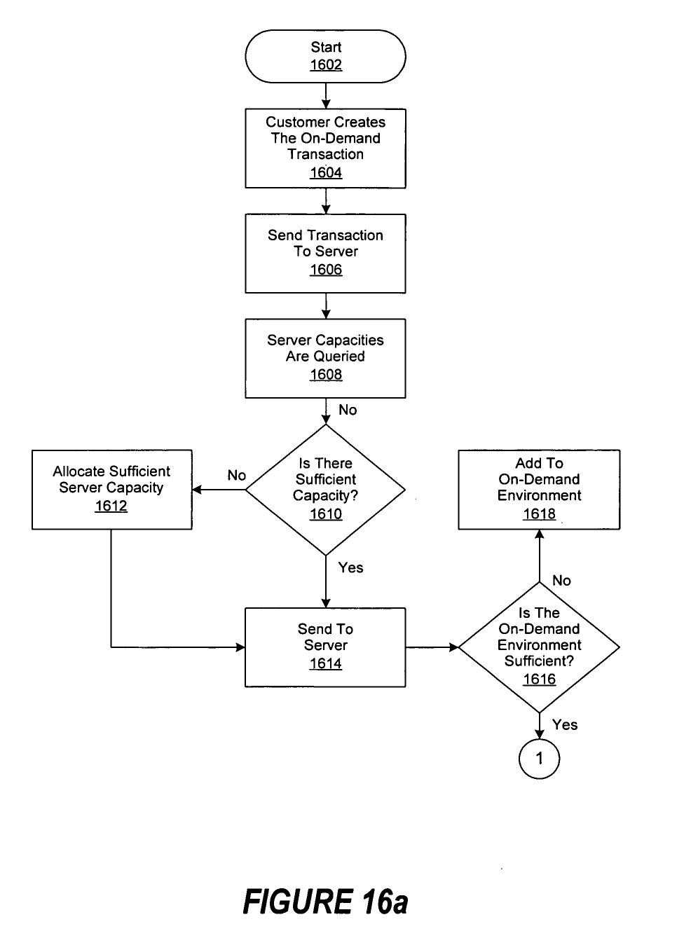

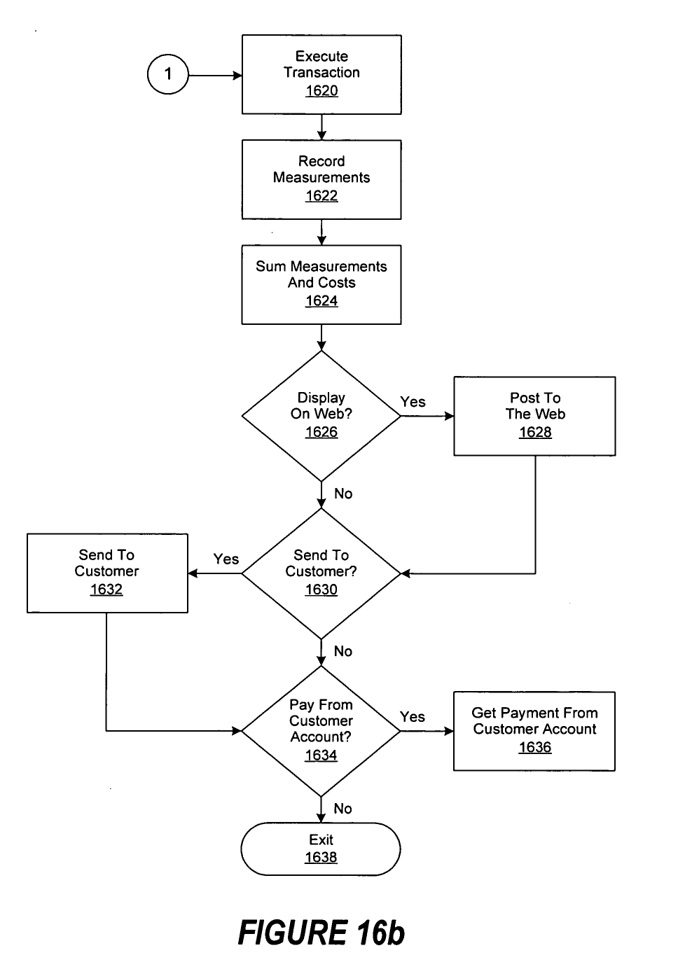

With reference now to FIG. 16, initiator block 1602 begins the On Demand process. A transaction is created than contains the unique customer identification, the requested service type and any service parameters that further, specify the type of service (block 1604). The transaction is then sent to the main server (block 1606). In an On Demand environment the main server can initially be the only server, then as capacity is consumed other servers are added to the On Demand environment.

The server central processing unit (CPU) capacities in the On Demand environment are queried (block 1608). The CPU requirement of the transaction is estimated, then the servers available CPU capacity in the On Demand environment are compared to the transaction CPU requirement to see if there is sufficient CPU available capacity in any server to process the transaction (query block 1610). If there is not sufficient server CPU available capacity, then additional server CPU capacity is allocated to process the transaction (block 1612). If there was already sufficient available CPU capacity then the transaction is sent to a selected server (block 1614).

Before executing the transaction, a check is made of the remaining On Demand environment to determine if the environment has sufficient available capacity for processing the transaction. This environment capacity consists of such things as but not limited to network bandwidth, processor memory, storage etc. (block 1616). If there is not sufficient available capacity, then capacity will be added to the On Demand environment (block 1618). Next the required software to process the transaction is accessed, loaded into memory, then the transaction is executed (block 1620).

The usage measurements are recorded (block 1622). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 1624).

If the customer has requested that the On Demand costs be posted to a web site (query block 1626), then they are posted (block 1628). If the customer has requested that the On Demand costs be sent via e-mail to a customer address (query block 1630), then these costs are sent to the customer (block 1632). If the customer has requested that the On Demand costs be paid directly from a customer account (query block 1634), then payment is received directly from the customer account (block 1636). The On Demand process is then exited at terminator block 1638.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method for automatically detecting hangs, deadlocks and bottlenecks in a virtual machine environment, the method comprising:
generating a plurality of thread dumps for an application executing in a virtual machine environment;
presenting graphical depictions of thread and resource contentions, the graphical depictions including indications for threads that are deadlocked in a circular wait condition and threads that are perpetually waiting on themselves, the indications providing alerts of potential problems within the virtual machine environment.

2. The computer-implementable method of claim 1 further comprising:
monitoring stack traces for each thread for a predetermined period of time and a predetermined number of thread dumps and a predetermined time interval between generating the plurality of thread dumps.

3. The computer-implementable method of claim 1 wherein:
the indications include indications for locked objects, and further comprising analyzing the locked objects to determine whether the locked objects are potentially stuck in a circular wait condition or waiting on themselves.

4. The computer-implementable method of claim 1 wherein:
thread stack traces from at least two thread dumps are compared to identify threads having a same stack trace, the same stack trace being marked as hung and then graphically depicted via the indications

5. The computer-implementable method of claim 1 wherein:
the presenting graphical depictions includes indications of deadlocks, the indications of deadlocks being identified by generating thread graphs from a monitor table and depth-first search trees.

6. The computer-implementable method of claim 5 wherein:
the depth-first search tree includes a plurality of tree levels; and,
each tree level is sorted by a number of waiting threads and if a hung thread is found in a tree, a root thread of the hung thread is located and marked as a bottleneck, and
the indications include an indication of the hung thread.

7. A system comprising:
a processor;
a data bus coupled to the processor; and
a computer-usable medium embodying computer program code, the computer-usable medium being coupled to the data bus, the computer program code comprising instructions executable by the processor and configured for:
generating a plurality of thread dumps for an application executing in a virtual machine environment;
presenting graphical depictions of thread and resource contentions, the graphical depictions including indications for threads that are deadlocked in a circular wait condition and threads that are perpetually waiting on themselves, the indications providing alerts of potential problems within the virtual machine environment.

8. The system of claim 7, wherein the instructions are further configured for:
monitoring stack traces for each thread for a predetermined period of time and a predetermined number of thread dumps and a predetermined time interval between generating the plurality of thread dumps.

9. The system of claim 7, wherein:
the indications include indications for locked objects, and further comprising
analyzing the locked objects to determine whether the locked objects are potentially stuck in a circular wait condition or waiting on themselves.

10. The system of claim 7, wherein:
thread stack traces from at least two thread dumps are compared to identify threads having a same stack trace, the same stack trace being marked as hung and then graphically depicted via the indications

11. The system of claim 7, wherein:
the presenting graphical depictions includes indications of deadlocks, the indications of deadlocks being identified by generating thread graphs from a monitor table and depth-first search trees.

12. The system of claim 7, wherein:
the depth-first search tree includes a plurality of tree levels;
each tree level is sorted by a number of waiting threads and if a hung thread is found in a tree, a root thread of the hung thread is located and marked as a bottleneck, and,
the indications include an indication of the hung thread.

13. A computer-usable medium embodying computer program code, the computer program code comprising computer executable instructions configured for:
generating a plurality of thread dumps for an application executing in a virtual machine environment;
presenting graphical depictions of thread and resource contentions, the graphical depictions including indications for threads that are deadlocked in a circular wait condition and threads that are perpetually waiting on themselves, the indications providing alerts of potential problems within the virtual machine environment.

14. The computer-usable medium of claim 13, wherein the embodied computer program code further comprises computer executable instructions configured for:
monitoring stack traces for each thread for a predetermined period of time and a predetermined number of thread dumps and a predetermined time interval between generating the plurality of thread dumps.

15. The computer-usable medium of claim 13, wherein:
the indications include indications for locked objects, and further comprising
analyzing the locked objects to determine whether the locked objects are potentially stuck in a circular wait condition or waiting on themselves.

16. The computer-usable medium of claim 13, wherein:
thread stack traces from at least two thread dumps are compared to identify threads having a same stack trace, the same stack trace being marked as hung and then graphically depicted via the indications

17. The computer-usable medium of claim 13, wherein:
the presenting graphical depictions includes indications of deadlocks, the indications of deadlocks being identified by generating thread graphs from a monitor table and depth-first search trees.

18. The computer-usable medium of claim 13, wherein:
the depth-first search tree includes a plurality of tree levels;
each tree level is sorted by a number of waiting threads and if a hung thread is found in a tree, a root thread of the hung thread is located and marked as a bottleneck, and,
the indications include an indication of the hung thread.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
